(19) United States
(12) Patent Application Publication
(10) Pub. No.: US 2020/0377717 A1
(43) Pub. Date: Dec. 3, 2020

(54) POLYMER COMPOSITION AND ARTICLE PREPARED THEREFROM AND METHOD FOR PREPARING RESIN COMPOSITION

(71) Applicant: FAR EASTERN NEW CENTURY CORPORATION, Taipei City (TW)

(72) Inventors: Yu-Cheng LIAO, Taipei City (TW); Mao-Yuan CHIU, Taipei City (TW); Li-Ling CHANG, Taipei City (TW)

(21) Appl. No.: 16/884,381

(22) Filed: May 27, 2020

Related U.S. Application Data
(60) Provisional application No. 62/853,961, filed on May 29, 2019.

(51) Int. Cl. C08L 67/00; C08L 77/06; C08G 69/26

(52) U.S. Cl. CPC C08L 67/00; C08K 5/092; C08G 69/26; C08L 77/06

(57) ABSTRACT

A polymer composition includes a polyester, a multifunctional compound, and a polymeric compound containing a salt of a metal. The multifunctional compound is one of polyacid, polyanhydride, and the combination thereof. Based on the polymer composition, the metal is present in an amount ranging from 0.01 mol % to 5.0 mol %. Also disclosed herein are an article prepared from the polymer composition and a method for preparing a resin composition from the polymer composition.

### CROSS-REFERENCE TO RELATED APPLICATION

This application claims priority of U.S. Provisional Application No. 62/853,961, filed on May 29, 2019.

### FIELD

The disclosure relates to a polymer composition capable of being easily processed into a plastic article.

### BACKGROUND

Polyester resins, such as poly(ethylene terephthalate) (PET), have long been used in the manufacturing of packaging materials, in which preforms are blown or otherwise oriented into a desired form necessary for producing articles, such as plastic containers and/or bottles that are used for storing and delivering food and beverage. Such plastic containers usually require high degree of melt strength and elasticity. It is well known that addition of a multifunctional compound (such as a polyanhydride) to melt-mix with PET can increase intrinsic viscosity of PET, so as to obtain resins or articles with good melt strength and elasticity (see U.S. Pat. Nos. 4,145,466 and 5,362,763).

Moreover, one known way to additionally increase gas barrier strength of the plastic container is to blend certain gas barrier strengthening fillers with the polyester resins of the plastic container. For example, certain polyamides well known in the art, such as polyxylylene amides, are provided to improve gas barrier strength of the plastic containers.

In order to obtain improved mechanical properties and to avoid peeling of plastic products, the polyester resin can be mixed with a dianhydride of a tetracarboxylic acid and the polyamide under melted conditions, so as to render the polymeric components theoretically compatible with each other (see U.S. Pat. No. 6,346,307 B1). However, to produce such plastic products, the polyester resin is required to be premixed with the dianhydride of the tetracarboxylic acid in a first granulation process, followed by mixing with the polyamide in a second granulation process. In addition, US Patent Application Publication No. US 2004/0013833 A1 discloses compatibilized polymer blends including polyamide, PET or a PET-containing copolymer, and a compatibilizer selected from IPA-modified PET and PET ionomers. Such compatibilized polymer blends are fabricated into monolayer or multilayer preforms and/or containers. Even though the compatibility (i.e., domain size) of the thus obtained plastic products in these applications may be acceptable, there is still room for improvement.

### SUMMARY

Therefore, an objective of the present disclosure is to provide a polymer composition, an article prepared therefrom, and a method for preparing a resin composition that can alleviate at least one of the drawbacks of the prior art.

In a first aspect, the polymer composition includes a polyester, a multifunctional compound, and a polymeric compound containing a salt of a metal. Based on the polymer composition, the metal is present in an amount ranging from 0.01 mol % to 5.0 mol %. The multifunctional compound is selected from the group consisting of polyacid, polyanhydride, and the combination thereof.

In a second aspect, the method of preparing the resin composition includes: melt-mixing the above-mentioned polymer composition under heating so as to obtain a mixture; and cooling the mixture.

In a third aspect, the article of this disclosure is prepared from the above-mentioned polymer composition.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless defined otherwise, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described. For the sake of clarity, the following definitions are used herein.

According to this disclosure, the polymer composition includes a polyester, a multifunctional compound, and a polymeric compound containing a salt of a metal. Based on the polymer composition, the metal is present in an amount ranging from 0.01 mol % to 5.0 mol %.

In certain embodiments, based on the polymer composition, the metal is present in an amount ranging from 0.01 mol % to 3.0 mol %.

In certain embodiments, based on the polymer composition, the metal is present in an amount ranging from 0.01 mol % to 2.0 mol %, e.g. 0.05 mol % to 1.75 mol %. In certain embodiments, based on the polymer composition, the metal is present in an amount ranging from 0.05 mol % to 1.4 mol %.

As used herein, the term “polyester” is understood to mean a synthetic polymer prepared by the polycondensation of one or more difunctional carboxylic acids with one or more difunctional hydroxyl compounds (e.g. diols) or the transesterification of diesters. The polyester may include, but is not limited to, aliphatic polyester, aromatic polyester, and the combination thereof.

In certain embodiments, the polyester is aliphatic polyester that includes 80 wt % of a reaction product obtained by polycondensation of an aliphatic diacid component and a diol component.

In other embodiments, the polyester is aromatic polyester that includes 80 wt % of a reaction product obtained by polycondensation of an aromatic diacid component and a diol component.

The aromatic diacid component may be an aromatic dicarboxylic acid component. Examples of the aromatic dicarboxylic acid component suitable for use in this disclosure may include, but are not limited to, terephthalic acid, isophthalic acid, phthalic acid, furandicarboxylic acid, and combinations thereof.

The aliphatic diacid component may be an aliphatic dicarboxylic acid component. The term “aliphatic-dicarboxylic acid”, as used herein, is used to denote straight or branched chain alkanedicarboxylic acids containing 2 to 20 carbons. Examples of the aliphatic dicarboxylic acid component suitable for use in this disclosure may include, but are not limited to, succinic acid, lactic acid, adipic acid, suberic acid, and the like.

Examples of the diol component suitable for use in this disclosure may include, but are not limited to, propylene glycol, 1,4-butanediol, neopentyl glycol, 2-methyl-1,3-propylene glycol, 1,4-cyclohexanedimethanol, polytetramethylene ether glycol, ethylene glycol, polyethylene glycol, and combinations thereof.

The polyester may be one of polyethylene terephthalate (PET), polyethylene naphthalate (PEN), polytrimethylene terephthalate (PTT), and poly(dimethyl cyclohexane terephthalate).

In an exemplary embodiment, the polyester is polyethylene terephthalate (PET), which may have an intrinsic viscosity ranging from 0.5 dl/g to 1.2 dl/g, and may have isophthalic acid (IPA) in an amount ranging from 1 mol % to 5 mol %.

The multifunctional compound may be polyacid, polyanhydride, or the combination thereof.

As used herein, the term “polyacid” refers to a compound having two or more acid groups and includes the ester and anhydride of the acid. That is, the term “polyacid” may also refer to acid anhydrides.

Examples of the multifunctional compound suitable for use in this disclosure may include, but are not limited to, tricarboxylic acid (such as trimesic acid), tricarboxylic acid anhydride (such as trimellitic anhydride), tetracarboxylic acid (such as pyromellitic acid), tetracarboxylic acid anhydride, tetracarboxylic dianhydride (such as pyromellitic dianhydride), and combinations thereof. In an exemplary embodiment, the multifunctional compound is pyromellitic dianhydride (PMDA).

In certain embodiments, the polymeric compound containing the salt of the metal has a number average molecular weight greater than 5000 Daltons.

In other embodiments, the polymeric compound containing the salt of the metal has a number average molecular weight greater than 10,000 Daltons.

The metal of the polymeric compound may have a positive valence of 1 or 2. Examples of the metal may include, but are not limited to, an alkali metal, an alkali earth metal, and the combination thereof.

In the polymeric compound containing the salt of the metal, the polymeric compound may be one of polyolefin copolymer, copolyester, ethylene-mathacrylic acid copolymer, ethylene-methylacrylate copolymer, ethylene-ethylacrylate copolymer, ethylene-butylacrylate copolymer, and combinations thereof.

As used herein, the term “copolyester” refers to a polyester which may be modified by one or more diol components other than ethylene glycol, or one or more acid components other than terephthalic acid.

The diol components suitable for modifying the copolyester may include, but are not limited to, 1,4-cyclohexane-dimethanol, 1,2-propanediol, 1,4-butanediol, 2,2-dimethyl-1,3-propanediol, 2-methyl-1,3-propanediol (2MPDO), 1,6-hexanediol, 1,2-cyclo-hexanediol, 1,4-cyclohexanediol, 1,2-cyclohexanedimethanol, 1,3-cyclohexanedimethanol, and diols containing one or more oxygen atoms in the chain, e.g., diethylene glycol, triethylene glycol, dipropylene glycol, tripropylene glycol, and mixtures thereof.

The acid components suitable for modifying the copolyester may include, but are not limited to, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalene-dicarboxylic acid, bibenzoic acid, and mixtures thereof.

In some embodiments, the polymeric compound is a copolyester of ethylene glycol with a combination of terephthalic acid and isophthalic acid and/or metal salt of 5-sulfoisophthalic acid. The copolyester may also be derived by modifying a polyester (PET) with the metal salt of sulfoisopthalate that is derived from the di-ester or di-carboxylic acid of sulfoisophthalate (SIPA). The metal may be lithium, sodium, potassium, zinc, magnesium, and calcium.

In certain embodiments, the polymeric compound containing the salt of the metal is an ionomer, such as an ionomer of ethylene and methacrylic acid (e.g., Surlyn® ionomers). In other embodiments, the polymeric compound containing the salt of the metal is a copolyester, such as a copolyester of ethylene terephthalate resin modified with sodium sulfoisophthalate (NaSIPE-co-PET). In still other embodiments, the polymeric compound containing the salt of the metal is a copolyester of ethylene terephthalate resin modified with lithium sulfoisophthalate (LiSIPE-co-PET). In yet still other embodiments, the polymeric compound containing the salt of the metal is cationic dyeable polyester resin modified with sodium sulfoisophthalate and poly(ethylene glycol) (CD-PET), which may have an intrinsic viscosity ranging from 0.4 dl/g to 0.7 dl/g, and may have poly(ethylene glycol) in an amount ranging from 2 wt % to 5 wt %, and sodium sulfoisophthalate in an amount ranging from 2 wt % to 15 wt %.

According to this disclosure, the polymer composition of this disclosure may further include a polyamide. In certain embodiments, based on the polymer composition including the polyamide, the metal is present in an amount ranging from 0.05 mol % to 3.0 mol %.

In other embodiments, based on the polymer composition including the polyamide, the metal is present in an amount ranging from 0.05 mol % to 2.0 mol %.

In other embodiments, based on the polymer composition including the polyamide, the metal is present in an amount ranging from 0.1 mol % to 1.4 mol %.

As used herein, the term “polyamide” is intended to include synthetic polymers prepared by the polycondensation of one or more difunctional carboxylic acids with one or more difunctional amines, or by the polycondensation of an aminocarboxylic acid.

In certain embodiments, the polyamide is prepared by the polycondensation of aminocaproic acid.

In other embodiments, the polyamide is prepared by the polycondensation of a diamine and a dicarboxylic acid with 6 to 22 carbon atoms. Examples of the dicarboxylic acid with 6 to 22 carbon atoms may include, but are not limited to, adipic acid, isophthalic acid, terephthalic acid, 1,4-cyclohexanedicarboxylic acid, resorcinol dicarboxylic acid, naphthalenedicarboxylic acid, and mixtures thereof. Examples of the diamine may include, but are not limited to, m-xylene diamine, p-xylene diamine, hexamethylenediamine, ethylene diamine, 1,4-cyclohexanedimethylamine, and mixtures thereof.

In an exemplary embodiment, the polyamide is prepared by the polycondensation of m-xylylene diamine (MXDA) and adipic acid. The resultant polyamide is poly(m-xylylene adipamide) (MXD-6), which may have a melt index ranging from 0.5 g/10 min to 7 g/10 min (tested at 275° C. under a load of 0.325 kg).

This disclosure also provides a method for preparing a resin composition, which includes the steps of: melt-mixing the above-mentioned polymer composition under heating, so as to obtain a mixture; and cooling the mixture.

The melt-mixing step may be conducted at a temperature ranging from 260° C. to 290° C. using, e.g., a single or twin screw extruder for granulation under a suitable operating condition (e.g., a rotation speed ranging from 60 rpm to 100 rpm).

The cooling step may be conducted via any suitable process well known in the art, e.g., placing the mixture in a water bath having a room temperature for fast cooling.

In certain embodiments, the method further includes a step of subjecting the mixture to a solid state polymerization before the cooling step.

It should be noted that, the multifunctional compound is capable of increasing the viscosity of the polyester, and the polymeric compound containing the salt of the metal also accelerates the viscosity-enhancing effect of the multifunctional compound and further improves the performance of the multifunctional compound in chain extension of the polyester and/or the polyamide (if the polyamide is present, the viscosity of the polyester would be close to that of the polyamide). Therefore, such polymer composition can be easily processed (such as granulation process) using single or twin screw extruder in a cost and time-efficient manner to produce a resin composition (e.g. in a pellet form).

In certain embodiments, based on the resin composition, the metal is present in an amount ranging from 0.01 mol % to 5.0 mol %.

In certain embodiments, based on the resin composition, the metal is present in an amount ranging from 0.01 mol % to 3.0 mol %.

In certain embodiments, based on the resin composition, the metal is present in an amount ranging from 0.01 mol % to 2.0 mol %.

In certain embodiments, based on the resin composition, the metal is present in an amount ranging from 0.05 mol % to 1.4 mol %.

In addition, the polymer composition of this disclosure can be used to prepare an article having desired and acceptable properties. Therefore, the present disclosure also provides an article which is prepared from the above-mentioned polymer composition.

According to this disclosure, the article may be prepared by blending the above-mentioned polymer composition, and then subjecting the resultant blend to any suitable manufacturing process (such as molding, casting and extruding) for producing the article.

Generally, the blending may be conducted without heat. If any components in the polymer composition require a heat treatment in advance, the blending may be conducted under heating.

In certain embodiments, the blending and the manufacturing process may be conducted simultaneously, e.g., via an injection molding machine. For example, by virtue of the injection molding machine, the blending and the manufacturing process (i.e., molding) may be conducted at a temperature ranging from 80° C. to 300° C. under a suitable operating condition, so as to obtain the article.

In certain embodiments, the blending is dry blending. As used herein, the term “dry blending” refers to the general technique in which the individual components are initially mixed together in a dry state through mechanical force, without employing any liquid to dissolve, suspend, and/or disperse the blend components. The methods and equipment for dry blending are known in the art. Any type of mechanical mixer or blender can be used, such as a ribbon blender. Alternatively, dry blending may also be conducted manually. It is understood that the components which are dry blended can be added to the blender concurrently or at different times in any order, and a particular component can be added all at once or in separate portions at different times during the dry blending.

According to this disclosure, the article may be prepared by subjecting the resin composition to the manufacturing process (such as molding, casting and extruding), in which the resin composition is obtained from the polymer composition through the above-mentioned method.

Examples of the article may include, but are not limited to, a preform, a bottle, a sheet, a container, a film, and the like.

In certain embodiments, the article is a preform, which may be prepared by subjecting the blend (the polymer composition) or the resin composition to injection molding using, e.g., an injection machine.

In certain embodiments, the article is a bottle, which may be prepared by further subjecting the preform to blow molding.

It is noted that when the polyamide is present in the polymer composition and the resultant blend or the resin composition obtained as described above is subjected to the manufacturing process (such as injection molding or blow molding), the articles thus prepared may generate dispersed domains due to the incompatibility of polyester and polyamide. By virtue of the multifunctional compound and the polymeric compound containing the salt of metal employed in this disclosure, the viscosity of the polyester would be close to that of the polyamide (i.e., compatibility of polyester and polyamide can be improved), so that the article prepared from the polymer composition of this disclosure exhibits dispersed domains with a reduced size. It is noted that since the dispersed domains are substantially spheriform, the size thereof may be referred to as the diameter.

According to this disclosure, the preform may have domains with an average size that is not greater than 150 nm. For example, the preform may have domains with an average size ranging from 30 nm to 150 nm. In certain embodiments, more than 80% of the domains of the preform have a size not greater than 200 nm. In other embodiments, more than 90% of the domains of the preform have a size not greater than 300 nm. In still other embodiments, more than 95% of the domains of the preform have a size not greater than 350 nm.

According to this disclosure, the bottle may have domains with an average size that is not greater than 300 nm. For example, the bottle may have domains with an average size ranging from of 100 nm to 270 nm. In certain embodiments, more than 70% of the domains of the article have a size not greater than 300 nm. In other embodiments, more than 80% of the domains of the article have a size not greater than 350 nm. In still other embodiments, more than 90% of the domains of the article have a size not greater than 400 nm.

In certain embodiments, based on the article, the metal is present in an amount ranging from 0.05 mol % to 3.0 mol %.

In certain embodiments, based on the article, the metal is present in an amount ranging from 0.05 mol % to 2.0 mol %.

In certain embodiments, based on the article, the metal is present in an amount ranging from 0.1 mol % to 1.4 mol %.

The disclosure will be further described by way of the following examples. However, it should be understood that the following examples are solely intended for the purpose of illustration and should not be construed as limiting the disclosure in practice.

### EXAMPLES

### General Experimental Materials:

### <P1 Resin> Crystalline Polyethylene Terephthalate Resin (Abbreviated as PET)

Crystalline PET resin used herein was purchased from Far Eastern New Century, model no. CB608, and has an intrinsic viscosity (abbreviated as IV) ranging from 0.5 dl/g to 1.2 dl/g.

### <P2 Powder> Pyromellitic Dianhydride (PMDA)

PMDA powder (industrial grade powder, purity >99%) was purchased from Lonza Group.

### <P3 Resin> Polyamide Resin

MXD-6, which is a polyamide resin polymerized with m-xylylenediamine and adipic acid, was purchased from Mitsubishi Gas Chemical, model no. S6007, and has a relative viscosity of 2.54.

### <P4 Resin> Surlyn

Surlyn® 8920 was purchased from DuPont, and is an ionomer polymerized from two monomers, i.e., ethylene and methacrylic acid. Surlyn® 8920 contains sodium ion in a range of 1.8 wt % to 2.3 wt %, has a melt index of 0.9 g/10 min (tested at 190° C. under a load of 2.16 kg), and a number average molecular weight ranging from 15000 Da to 20000 Da.

<P5 Resin> Ethylene Terephthalate Resin Modified with Sodium Sulfoisophthalate (NaSIPE-co-PET)

5082.4 g of terephthalic acid, 67.4 g of isophthalic acid, 77.8 g of sodium sulfoisophthalate, 2422.1 g of ethylene glycol, and 0.4 g of sodium acetate were respectively added into a reactor to mix under heating. When the amount of water thus generated reached theoretical value of esterification, 300 ppm of antimony trioxide and 30 ppm of phosphoric acid were added for conducting polymerization reaction at 275° C. under vacuum, so as to achieve an intrinsic viscosity (abbreviated as IV) that ranges from 0.4 dl/g to 0.6 dl/g. Then, solid phase polymerization was carried out at 220° C. under vacuum for 12 hours, and then at 230° C. under vacuum for 12 hours, so as to increase the IV to a range from 0.7 dl/g to 1.0 dl/g, thereby obtaining a crystalline NaSIPE-co-PET resin with a number average molecular weight ranging from 32000 Da to 39000 Da.

<P6 Resin> Ethylene Terephthalate Resin Modified with lithium sulfoisophthalate (LiSIPE-co-PET)

5082.4 g of terephthalic acid, 67.4 g of isophthalic acid, 74.4 g of lithium sulfoisophthalate, 2422.1 g of ethylene glycol, and 1.8 g of lithium acetate were respectively added into a reactor to mix under heating. When the amount of water thus generated reached theoretical value of esterification, 300 ppm of antimony trioxide and 30 ppm of phosphoric acid were added for conducting polymerization reaction at 275° C. under vacuum, so as to achieve an intrinsic viscosity (abbreviated as IV) that ranges from 0.4 dl/g to 0.6 dl/g. Then, solid phase polymerization was carried out at 220° C. under vacuum for 12 hours, and then at 230° C. under vacuum for 12 hours, so as to increase the IV to a range from 0.7 dl/g to 1.0 dl/g, thereby obtaining a crystalline LiSIPE-co-PET resin with a number average molecular weight ranging from 10000 Da to 15000 Da.

<P7 Resin> Cationic Dyeable Polyester Resin Modified with Sodium Sulfoisophthalate and Poly(Ethylene Glycol) (CD-PET)

Polyester resin modified with sodium sulfoisophthalate and poly(ethylene glycol) used herein may have an intrinsic viscosity ranging from 0.4 dl/g to 0.7 dl/g, and has poly(ethylene glycol) in an amount of 2.5 wt %, and sodium sulfoisophthalate in an amount of 2.5 wt %.

### General Experimental Procedures:

### A. Preparation of a Resin Composition Using a Twin Screw Rheometer

First, a polymer composition including specific components (i.e., the abovementioned resins and/or powders in a predetermined ratio) was provided. These components of the polymer composition were mixed and melted in a twin screw rheometer (e.g., Haake torque rheometer) at 270° C. and under a rotation speed of 60 rpm for a reaction time ranging from 300 to 900 seconds. The thus produced mixture (i.e., melted product) was placed in a water bath at room temperature for fast cooling so as to obtain a resin composition.

### Property Evaluation:

### 1. Determination of Torque

Torque value of screw for each polymer composition was determined using the Haake torque rheometer equipped with computer software. When 60 g of the resin or powder was initially added, an instantaneous increase in the torque value was observed, which indicates the resin or powder was being added or melted. Also, the overall viscosity of melted product (intrinsic viscosity) continued to increase when the resin and powder stayed in the rheometer. After all of the resins or powders were completely melted, the thus obtained maximum torque for each polymer composition and the time for reaching the maximum torque were determined. A maximum torque difference, expressed as ΔTₘₐₓ (Nm), is obtained by subtracting a baseline value from the determined maximum torque, in which the baseline value is the torque value of screw for a control composition including P1 resin only (for Examples 1 and 2) or including P1 and P3 resins in a weight ratio of 95:5 (for Examples 3 and 5) at the time for a respective one of the polymer compositions reaching the maximum torque.

### 2. Determination of Metal Content by Inductively Coupled Plasma Spectrometry (ICPS)

First, 5 ml of concentrated nitric acid was added to 0.15 g of the resin composition (obtained in section A of “General Experimental Procedures”) which was placed in a column, for conducting nitrification reaction for 1 hour at a predetermined temperature and pressure. After left standing and cooling, the reaction product was diluted using deionized water to a volume of 25 mL in a volumetric flask, so as to obtain a test sample for ICPS. Then, the test sample was injected into an inductively coupled plasma spectrometer according to US EPA 3052 method for determination of metal content thereof.

### 3. Analysis of Dispersed Domain Size

The preform or bottle was immersed in liquid nitrogen for 30 minutes, and then struck and cut cross-sectionally. The cross-sectionally cut test sample was then placed into a 20 ml vial and covered with 96% formic acid (ACS grade solvent, purchased from Sigma-Aldrich) for one hour. Thereafter, the test sample was rinsed several times with deionized water until the rinsed deionized water achieves a neutral pH, and then dried to obtain a specimen. The specimen was placed in an agar auto sputter coater and plated with gold or platinum so as to make the specimen electrically conductive. After that, the thus coated specimen was subjected to imaging of dispersed domain size thereof using a scanning electron microscope (SEM) (Manufacturer: Jeol USA, Inc.; Model No.: JSM-6701F) after placing into a SEM holder. Subsequently, a few enlarged images (5000× or more) of each of the specimens were randomly selected for observing and calculating the dispersed domain size.

### Example 1

### <Experimental Groups A to C (EG-A to EG-C)>

A resin composition of Experimental Group A (EG-A) was prepared from polymer composition according to the method set forth in section A of “General Experimental Procedures”. To be specific, P1 resin was dried in a hot air oven at 140° C. for 12 hours, and P4 resin was dehumidified and dried at a dew point of 80° C. for 24 hours. P2 powder and P1 and P4 resins were mixed in weight ratios as shown in Table 1, and then placed into a Haake torque rheometer for melting at a predetermined temperature of 270° C. and a rotation speed of 60 rpm for a given time. The melted product was further obtained as a resin composition of EG-A.

The procedures and conditions for EG-B were similar to those of EG-A, except that P4 resin was replaced with P5 resin, which was dried in a hot air oven at 140° C. for 12 hours. Thereafter, P2 and P5 resins were evenly mixed with P1 resin in weight ratios as shown in Table 1.

The procedures and conditions for EG-C were similar to those of EG-A, except that P4 resin was replaced with P6 resin, which was dried in a hot air oven at 140° C. for 12 hours.

### <Comparative Groups A to C (CG-A to CG-C)>

The procedures and conditions for CG-A to CG-C were similar to those of EG-A, except that P4 resin was replaced with P1 resin in CG-A, replaced with sodium carbonate (Na₂CO₃, purchased from Sigma-Aldrich) dried in a hot air oven at 140° C. for 12 hours in CG-B, and replaced with sodium chloride (NaCl, purchased from Sigma-Aldrich) in CG-C.

The polymer compositions for preparing each of the resin compositions were shown in Table 1.

TABLE 1

| | Polymer composition (wt %) | | | | | | |
|---|---|---|---|---|---|---|---|
| Groups | P1 | P2 | P4 | P5 | P6 | Na₂CO₃ | NaCl |
| EG-A | 96.5 | 0.5 | 3 | — | — | — | — |
| EG-B | 24.5 | 0.5 | — | 75 | — | — | — |
| EG-C | 24.5 | 0.5 | — | — | 75 | — | — |
| CG-A | 99.5 | 0.5 | — | — | — | — | — |
| CG-B | 99.36 | 0.5 | — | — | — | 0.14 | — |
| CG-C | 99.35 | 0.5 | — | — | — | — | 0.15 |

According to the methods set forth in sections 1 and 2 of “Property Evaluation”, the polymer compositions of each of EG-A to EG-C and CG-A to CG-C were subjected to torque value measurement and determination of metal content using ICPS. The thus determined maximum torque difference, the time to reach the maximum torque, and the metal content for each group were shown in Table 2.

TABLE 2

| | | Time | Metal content | | Metal content | |
|---|---|---|---|---|---|---|
| | ΔTₘₐₓ | (sec, | added | | determined by ICPS | |
| Groups | (Nm) | max) | (ppm) | (mol %) | (ppm) | (mol %) |
| EG-A | 5.8 | 195 | 600 | 0.525 | 487 | 0.426 |
| EG-B | 7.6 | 213 | 600 | 0.525 | 430 | 0.376 |
| EG-C | 9.0 | 193 | 189 | 0.525 | 133 | 0.369 |
| CG-A | 4.4 | 371 | 0 | 0 | 0 | 0 |
| CG-B | 5.7 | 316 | 600 | 0.525 | 168 | 0.147 |
| CG-C | 5.5 | 389 | 600 | 0.525 | 463 | 0.405 |

As shown in Table 2, the maximum torque difference of the polymer compositions in each of EG-A to EG-C is greater than those of CG-A to CG-C. In addition, the polymer compositions in each of EG-A to EG-C took less time to reach the maximum torque as compared to those of CG-A to CG-C, indicating the viscosity (intrinsic viscosity) of the melted product in EG-A to EG-C increases more quickly. The results indicate that under the same content of added metal, the polymeric compound containing the metal salt may accelerate the increase in viscosity, and improve the performance of PMDA in chain extension of the polyester as compared to non-polymeric metal salts (i.e., CG-B to CG-C).

### Example 2

### A. Content Variation of P4 Resin (Surlyn)

To investigate the effect of P4 resin (Surlyn), resin compositions of Experimental Groups A1 to A5 (EG-A1 to EG-A5) prepared from polymer compositions with different wt % of P4 resin as shown in Table 3 were further prepared and analyzed according to the procedures and conditions as described for EG-A. The thus determined maximum torque difference, the time to reach the maximum torque, and the metal content for each group were shown in Table 4.

TABLE 3

| | Polymer composition (wt %) | | |
|---|---|---|---|
| Group | P1 | P2 | P4 |
| EG-A1 | 99.417 | 0.5 | 0.083 |
| EG-A2 | 99.35 | 0.5 | 0.15 |
| EG-A3 | 99.3 | 0.5 | 0.2 |
| EG-A4 | 99.1 | 0.5 | 0.4 |
| EG-A | 96.5 | 0.5 | 3.0 |
| EG-A5 | 89.5 | 0.5 | 10.0 |

TABLE 4

| | | | | | | Metal content | |
|---|---|---|---|---|---|---|---|
| | P4 | | Time | Metal content | | determined by | |
| | resin | ΔTₘₐₓ | (sec, | added | | ICPS | |
| Group | (wt %) | (Nm) | max) | (ppm) | (mol %) | (ppm) | (mol %) |
| CG-A | 0 | 4.4 | 371 | 0 | 0 | 0 | 0 |
| EG-A1 | 0.083 | 5.6 | 271 | 16.6 | 0.015 | 11.3 | 0.010 |
| EG-A2 | 0.15 | 5.3 | 252 | 30 | 0.026 | 24.7 | 0.022 |
| EG-A3 | 0.2 | 5.6 | 247 | 40 | 0.035 | 46.4 | 0.041 |
| EG-A4 | 0.4 | 5.7 | 243 | 80 | 0.070 | 57.5 | 0.050 |
| EG-A | 3.0 | 5.8 | 195 | 600 | 0.525 | 487 | 0.426 |
| EG-A5 | 10.0 | 5.9 | 101 | 2000 | 1.750 | 1520 | 1.330 |

As shown in Table 4, the maximum torque difference of the polymer compositions in each of EG-A, and EG-A1 to EG-A5 is greater than that in CG-A. In particular, by increasing the amount of P4 resin, the maximum torque difference of the polymer compositions increases and the time to reach the maximum torque decreases.

### B. Content Variation of P5 Resin (NaSIPE-co-PET)

To investigate the effect of P5 resin (NaSIPE-co-PET), resin compositions of Experimental Groups B1 to B3 (EG-B1 to EG-B3) prepared from polymer compositions with different wt % of P5 resin as shown in Table 5 were further prepared and analyzed according to the procedures and conditions as described for EG-B. The thus determined maximum torque difference, the time to reach the maximum torque, and the metal content for each group were shown in Table 6.

TABLE 5

| | Polymer composition (wt %) | | |
|---|---|---|---|
| Group | P1 | P2 | P5 |
| EG-B1 | 74.5 | 0.5 | 25 |
| EG-B2 | 49.5 | 0.5 | 50 |
| EG-B | 24.5 | 0.5 | 75 |
| EG-B3 | 9.5 | 0.5 | 90 |

TABLE 6

| | | | | | | Metal content | |
|---|---|---|---|---|---|---|---|
| | P5 | | Time | Metal content | | determined by | |
| | resin | ΔTₘₐₓ | (sec, | added | | ICPS | |
| Group | (wt %) | (Nm) | max) | (ppm) | (mol %) | (ppm) | (mol %) |
| CG-A | 0 | 4.4 | 371 | 0 | 0 | 0 | 0 |
| EG-B1 | 25 | 5.1 | 247 | 200 | 0.175 | 152 | 0.133 |
| EG-B2 | 50 | 7.0 | 227 | 400 | 0.350 | 342 | 0.299 |
| EG-B | 75 | 7.6 | 213 | 600 | 0.525 | 430 | 0.376 |
| EG-B3 | 90 | 8.8 | 204 | 720 | 0.630 | 621 | 0.543 |

As shown in Table 6, the maximum torque difference of the polymer compositions in each of EG-B and EG-B1 to EG-B3 is greater than that in CG-A. In particular, by increasing the amount of P5 resin, the maximum torque difference of the polymer compositions increases and the time to reach the maximum torque decreases.

### C. Content Variation of P6 Resin (LiSIPE-co-PET)

To investigate the effect of P6 resin (LiSIPE-co-PET), resin compositions of Experimental Groups C1 and C2 (EG-C1 to EG-C2) prepared from polymer compositions with different wt % of P6 resin as shown in Table 7 were prepared and analyzed according to the procedures and conditions as described for EG-C. The thus determined maximum torque difference, the time to reach the maximum torque, and the metal content for each group were shown in Table 8.

TABLE 7

| | Polymer composition (wt %) | | |
|---|---|---|---|
| Group | P1 | P2 | P6 |
| EG-C1 | 74.5 | 0.5 | 25 |
| EG-C | 24.5 | 0.5 | 75 |
| EG-C2 | 9.5 | 0.5 | 90 |

TABLE 8

| | | | | | | Metal content | |
|---|---|---|---|---|---|---|---|
| | P6 | | Time | Metal content | | determined by | |
| | resin | ΔTₘₐₓ | (sec, | added | | ICPS | |
| Group | (wt %) | (Nm) | max) | (ppm) | (mol %) | (ppm) | (mol %) |
| CG-A | 0 | 4.4 | 371 | 0 | 0 | 0 | 0 |
| EG-C1 | 25 | 5.7 | 237 | 63 | 0.175 | 44.1 | 0.123 |
| EG-C | 75 | 9.0 | 193 | 189 | 0.525 | 133 | 0.369 |
| EG-C2 | 90 | 9.8 | 169 | 227 | 0.630 | 186 | 0.517 |

As shown in Table 8, the maximum torque of the polymer compositions in each of EG-C1, EG-C and EG-C2 is greater than that in CG-A, and the maximum torque difference of the polymer compositions increases when the amount of P6 resin increases. In addition, the time to reach the maximum torque decreases when the amount of P6 resin added increases.

The above results indicate that the polymeric compound containing the metal salt may accelerate the increase in intrinsic viscosity, and improve the performance of PMDA in chain extension of the polyester, and such improved effect is enhanced with the increased amount of the polymeric compound containing the metal salt.

### Example 3

### <Experimental Group 1 (EG1)>

A resin composition of Experimental Group 1 (EG1) was prepared from the polymer composition according to the method set forth in section A of “General Experimental Procedures”. First, P1 resin was dried in a hot air oven at 140° C. for 12 hours, and P3 and P4 resins were dehumidified and dried at a dew point of 80° C. for 24 hours. Then, P2 powder, and P1, P3 and P4 resins were mixed in weight ratios as shown in Table 9, and then placed into a Haake torque rheometer for melting at a predetermined temperature of 270° C. and a rotation speed of 60 rpm for a given time. The melted product was further obtained as a resin composition of EG1.

### <Experimental Group 2 (EG2)>

The procedures and conditions for EG2 were similar to those of EG1, except that P4 resin was replaced with P5 resin, which was dried in a hot air oven at 140° C. for 12 hours.

### <Experimental Group (EG3)>

The procedures and conditions for EG3 were similar to those of EG1, except that P4 resin was replaced with P6 resin, which was dried in a hot air oven at 140° C. for 12 hours.

### <Experimental Group 4 (EG4)>

The procedures and conditions for EG4 were similar to those of EG1, except that P4 resin was replaced with P7 resin.

The polymer compositions for preparing each of the resin compositions of EG1 to EG4 were shown in Table 9.

TABLE 9

| | Polymer composition (wt %) | | | | | | |
|---|---|---|---|---|---|---|---|
| Group | P1 | P2 | P3 | P4 | P5 | P6 | P7 |
| EG1 | 91.5 | 0.5 | 5 | 3 | — | — | — |
| EG2 | 19.5 | 0.5 | 5 | — | 75 | — | — |
| EG3 | 19.5 | 0.5 | 5 | — | — | 75 | — |
| EG4 | 63.9 | 0.5 | 5 | — | — | — | 30.6 |

### <Comparative Group 1 (CG1)>

The procedures and conditions for CG1 were similar to those of EG1, except that P4 resin was replaced with P1 resin.

### <Comparative Group 2 (CG2)>

The procedures and conditions for CG2 were similar to those of EG1, except that P4 resin was replaced with a predetermined amount of sodium carbonate (Na₂CO₃, purchased from. Sigma-Aldrich), which was dried in a hot air oven at 140° C. for 12 hours.

### <Comparative Group 3 (CG3)>

The procedures and conditions for CG3 were similar to those of EG1, except that P4 resin was replaced with a predetermined amount of sodium hydroxide (NaOH, purchased from Macron Fine Chemicals).

### <Comparative Group 4 (CG4)>

The procedures and conditions for CG4 were similar to those of EG1, except that P4 resin was replaced with a predetermined amount of sodium sulfoisophthalate (NaSIPA, purchased from Chung Hwa Chemical Industrial Works, Ltd., Taiwan).

### <Comparative Group 5 (CG5)>

The procedures and conditions for CG5 were similar to those of EG1, except that P4 resin was replaced with a predetermined amount of sodium chloride (NaCl, purchased from Sigma-Aldrich).

The polymer compositions for preparing each of the resin compositions of CG1 to CG5 were shown in Table 10.

TABLE 10

| | Polymer composition (wt %) | | | | | | |
|---|---|---|---|---|---|---|---|
| Group | P1 | P2 | P3 | Na₂CO₃ | NaOH | NaSIPA | NaCl |
| CG1 | 94.5 | 0.5 | 5 | — | — | — | — |
| CG2 | 94.36 | 0.5 | 5 | 0.14 | — | — | — |
| CG3 | 94.4 | 0.5 | 5 | — | 0.1 | — | — |
| CG4 | 93.8 | 0.5 | 5 | — | — | 0.7 | — |
| CG5 | 94.35 | 0.5 | 5 | — | — | — | 0.15 |

According to the methods set forth in sections 1 and 2 of “Property Evaluation”, the polymer compositions of each of EG1 to EG4 and CG1 to CG5 were subjected to torque value measurement and determination of metal content using ICPS. The thus determined maximum torque difference, the time to reach the maximum torque, and the metal content for each group were shown in Table 11.

TABLE 11

| | | | | | Metal content | |
|---|---|---|---|---|---|---|
| | | Time | Metal content | | determined by | |
| | ΔTₘₐₓ | (sec, | added | | ICPS | |
| Group | (Nm) | max) | (ppm) | (mol %) | (ppm) | (mol %) |
| EG1 | 2.9 | 176 | 600 | 0.525 | 559 | 0.49 |
| EG2 | 4.2 | 196 | 600 | 0.525 | 555 | 0.49 |
| EG3 | 4.9 | 176 | 189 | 0.525 | 135 | 0.38 |
| EG4 | 2.9 | 210 | 600 | 0.525 | 511 | 0.45 |
| CG1 | 2.1 | 272 | 0 | 0 | 0 | 0 |
| CG2 | 1.4 | 235 | 600 | 0.525 | 258 | 0.23 |
| CG3 | 0.5 | 245 | 600 | 0.525 | 486 | 0.43 |
| CG4 | 0.4 | 238 | 600 | 0.525 | 506 | 0.44 |
| CGS | 2.4 | 275 | 600 | 0.525 | 279 | 0.24 |

As shown in Table 11, the maximum torque difference of the polymer compositions in each of EG1 to EG4 is greater than those in CG1 to CG5. In addition, the polymer compositions in each of EG1 to EG4 took less time to reach the maximum torque as compared to those in CG1 to CG5, indicating the viscosity (intrinsic viscosity) of the melted product in EG1 to EG4 increases more quickly. The results indicate that under the same added metal content, the polymeric compound containing the metal salt (such as P4 to P7 resins used in EG1 to EG4) may accelerate the increase in viscosity, and improve the performance of PMDA in chain extension of the polyester and the polyamide, and thus facilitate the compatibility of PET and MXD6 as compared to non-polymeric metal salts (i.e., CG2 to CG5).

### Example 4

### <Experimental Group 5 (EG5)>

In EG5, the polymer composition including 64.9 wt % of P1 resin, 0.1 wt % of P2 powder, 5 wt % of P3 resin and 30 wt % of P5 resin was predried in a hot air oven at 140° C. for 12 hours and then dry blended, and then directly placed into a Husky injection machine at a temperature ranging from 255° C. to 300° C. for injection molding, so as to obtain a preform having a weight of about 22.5 grams. Subsequently, the preform was subjected to molding using Sidel blow molding machine, thereby obtaining a bottle having a volume of 0.6 L.

### <Experimental Group 6 (EG6)>

The polymer composition of EG6, which has a formulation similar to that of EG5 except that P5 resin used in EG5 was replaced with P6 resin, was subjected to dry blending, injection molding and blow molding process under the same conditions as those described in EG5, so as to obtain a preform having a weight of about 22.5 grams and a bottle having a volume of 0.6 L.

### <Comparative Group 6 (CG6)>

The polymer composition of CG6 includes 94.9 wt % of P1 resin, 0.1 wt % of P2 powder and 5 wt % of P3 resin. The procedures and conditions to obtain a preform and a bottle of CG6 were described in details as follows.

To be specific, after drying under conditions as those of EG1, crystallized granules of P1 resin at a feeding rate of 30 kg/h and P2 powder at a feeding rate of 0.03 kg/h were fed into a twin screw extruder at a temperature of 280° C. and a rotation speed of 100 rpm for pelletization. The thus obtained pellets containing 0.1 wt % PMDA were crystallized in a hot air oven at 140° C. for 12 hours, and then directly mixed with P3 resin in an amount of 5 wt %. The mixture was then added into the twin screw extruder again at a temperature of ranging from 260° C. to 270° C., a feeding rate of 30 kg/h, and a rotation speed of 100 rpm for melt-extrusion and granulation. The thus obtained resin composition was further crystallized in a hot air oven at 140° C. for 12 hours, and then directly placed into an injection machine at a temperature ranging from 255° C. to 300° C., so as to obtain a preform having a weight of about 22.5 grams. Subsequently, the preform was subjected to blow molding so as to obtain a bottle having a volume of 0.6 L.

### <Comparative Group 7 (CG7)>

The polymer composition of CG7, which includes 94.9 wt % of P1 resin, 0.1 wt % of P2 powder, and 5 wt % of P3 resin, was subjected to dry blending, injection molding and blow molding process under the same conditions as those described in EG5, so as to obtain a preform having a weight of about 22.5 grams and a bottle having a volume of 0.6 L.

The bottles of each of EG5 to EG6 were subjected to determination of metal content using ICPS according to the method set forth in section 2 of “Property Evaluation”, except that the resin composition to be analyzed is replaced by a slice cut from the bottle. In addition, the preforms and the bottles of each of EG5 to EG6 and CG6 to CG7 were subjected to the analysis of dispersed domain size according to the method set forth in section 3 of “Property Evaluation”. The metal content for EG5 to EG6, and the calculated average values and distribution ratios of the domain size for the preforms and the bottles of each group were shown in Tables 12 to 14.

TABLE 12

| | |
|---|---|
| Metal content | Metal content |
| added | determined by ICPS |

| Group | (ppm) | (mol %) | (ppm) | (mol %) |
|---|---|---|---|---|
| EG-5 | 240 | 0.21 | 244 | 0.21 |
| EG-6 | 76 | 0.21 | 72 | 0.20 |

TABLE 13

| | Average | | | | | |
|---|---|---|---|---|---|---|
| | domain | | | | | |
| | size | Distribution ratio of domain size | | | | |
| Preform | (nm) | <125 nm | <200 nm | <300 nm | <350 nm | <400 nm |
| EG5 | 143 | 59% | 81% | 94% | 96% | 97% |
| EG6 | 114 | 69% | 93% | 98% | 99% | 99% |
| CG6 | 261 | 14% | 38% | 68% | 80% | 86% |
| CG7 | 263 | 12% | 32% | 62% | 74% | 86% |

TABLE 14

| | Average | | | | |
|---|---|---|---|---|---|
| | domain | Distribution ratio of domain size | | | |
| Bottle | size (nm) | <200 nm | <300 nm | <350 nm | <400 nm |
| EG5 | 252 | 37% | 70% | 82% | 91% |
| EG6 | 207 | 59% | 83% | 89% | 93% |
| CG6 | 527 | 5% | 17% | 24% | 34% |
| CG7 | 580 | 3% | 12% | 16% | 26% |

As shown in Tables 13 and 14, the domain size of the articles (either preform or the bottle) of each of CG6 and CG7 is much larger than the domain size of EG5 and EG6. The analysis of the domain size also shows a much narrower distribution for EG5 and EG6.

In addition, as compared to CG6, where P1 resin and P2 powder were pelletized in advance before mixing with P3 resin in an extruder for melt-extrusion and further granulation, the polymer compositions of EG5 and EG6 can be obtained in an efficient manner by directly blending P1 resin, P2 powder and P3 resin in the presence of the polymeric compound containing the metal salt in one step, and an article (such as preform and bottle) obtained thereby has a desired and improved appearance. That is, in EG5 and EG6, pelletizaion or granulation through the extruder can be waived and thus there is no need to crystallize resins or granules. Further solid state polymerization (SSP) before molding process can also be dispensed since the polymeric compound containing the metal salt can enhance the performance of the multifunctional compound in chain extension and viscosity increase. Therefore, the polymer composition of this disclosure can be simply processed in a cost and time-efficient manner. Such simplified procedures may eliminate the well known negative effect caused by high reactivity and activity of the multifunctional compound. Although the polymer composition of CG7 is processed using the procedures similar to those for EG5, it lacks the polymeric compound containing the metal salt, and the thus obtained article has poor appearance due to the unacceptable domain size.

### Example 5

### A. Content Variation of P4 Resin (Surlyn)

To investigate the effect of P4 resin (Surlyn), resin compositions of Experimental Groups 7 to 10 (EG7 to EG10) prepared from the polymer compositions with different wt % of P4 resin as shown in Table 15 were prepared and analyzed according to the procedures and conditions as described for EG1. The thus determined of maximum torque difference, the time to reach the maximum torque, and the metal content were shown in Table 16.

TABLE 15

Polymer composition (wt %)

| Group | P1 | P2 | P3 | P4 |
|---|---|---|---|---|
| EG7 | 94.25 | 0.5 | 5 | 0.25 |
| EG8 | 94 | 0.5 | 5 | 0.5 |
| EG9 | 93.5 | 0.5 | 5 | 1.0 |
| EG10 | 86.5 | 0.5 | 5 | 8.0 |

TABLE 16

| | P4 | | Time | Metal content | | Metal content | |
|---|---|---|---|---|---|---|---|
| | resin | ΔTₘₐₓ | (sec, | added | | determined by | |
| Group | (wt %) | (Nm) | max) | (ppm) | (mol %) | (ppm) | (mol %) |
| CG1 | 0 | 2.1 | 272 | 0 | 0 | 0 | 0 |
| EG7 | 0.25 | 2.2 | 226 | 50 | 0.044 | 52.2 | 0.044 |
| EG8 | 0.5 | 2.2 | 211 | 100 | 0.088 | 89.5 | 0.078 |
| EG9 | 1 | 2.7 | 194 | 200 | 0.175 | 164 | 0.144 |
| EG1 | 3 | 2.9 | 176 | 600 | 0.525 | 559 | 0.49 |
| EG10 | 8 | 3.9 | 105 | 1600 | 1.400 | 1400 | 1.225 |

As shown in Table 16, the maximum torque difference in each of EG1 and EG7 to EG10 is greater than that in CG1. In particular, by increasing the amount of P4 resin, the maximum torque difference increases. In addition, the time to reach the maximum torque decreases when the amount of P4 resin added increases.

### B. Content Variation of P5 Resin (NaSIPE-co-PET)

To investigate the effect of P5 resin (NaSIPE-co-PET), resin compositions of Experimental Groups 11 to 14 (EG11 to EG14) prepared from the polymer compositions with different wt % of P5 resin as shown in Table 17, were prepared and analyzed according to the procedures and conditions as described for EG2. The thus determined maximum torque difference, the time to reach the maximum torque, and the metal content were shown in Table 18.

TABLE 17

Polymer composition (wt %)

| Group | P1 | P2 | P3 | P5 |
|---|---|---|---|---|
| EG11 | 69.5 | 0.5 | 5 | 25 |
| EG12 | 64.5 | 0.5 | 5 | 30 |
| EG13 | 44.5 | 0.5 | 5 | 50 |
| EG14 | 9.5 | 0.5 | 5 | 85 |

TABLE 18

| | | | | | | Metal content | |
|---|---|---|---|---|---|---|---|
| | P5 | | Time | Metal content | | determined by | |
| | resin | ΔTₘₐₓ | (sec, | added | | ICPS | |
| Group | (wt %) | (Nm) | max) | (ppm) | (mol %) | (ppm) | (mol %) |
| CG1 | 0 | 2.1 | 272 | 0 | 0 | 0 | 0 |
| EG11 | 25 | 4.2 | 213 | 200 | 0.175 | 151 | 0.132 |
| EG12 | 30 | 4.4 | 208 | 240 | 0.210 | 170 | 0.149 |
| EG13 | 50 | 6.5 | 198 | 400 | 0.350 | 293 | 0.256 |
| EG14 | 85 | 3.2 | 176 | 680 | 0.595 | 524 | 0.459 |

As shown in Table 18, the maximum torque difference in each of EG11 to EG14 is much greater than that in CG1. In EG11 to EG13, the maximum torque difference increases when the amount of P5 resin increases. Although the maximum torque difference in EG14 is slightly lower than those in EG11 to EG13 (probably because of relatively lower amount of P1 resin in EG14), the time to reach the maximum torque decreases when the amount of P5 resin added increases.

### C. Content Variation of P6 Resin (LiSIPE-co-PET)

To investigate the effect of P6 resin (LiSIPE-co-PET), resin compositions of Experimental Groups 15 to 18 (EG15 to EG18) prepared from the polymer compositions with different wt % of P6 resin as shown in Table 19, were prepared and analyzed according to the procedures and conditions as described for EG3. The thus determined maximum torque, the time to reach the maximum torque, and the metal content were shown in Table 20.

TABLE 19

Polymer composition (wt %)

| Group | P1 | P2 | P3 | P6 |
|---|---|---|---|---|
| EG15 | 69.5 | 0.5 | 5 | 25 |
| EG16 | 64.5 | 0.5 | 5 | 30 |
| EG17 | 44.5 | 0.5 | 5 | 50 |
| EG18 | 9.5 | 0.5 | 5 | 85 |

TABLE 20

| | | | | | | Metal content | |
|---|---|---|---|---|---|---|---|
| | P6 | | Time | Metal content | | determined by | |
| | resin | ΔTₘₐₓ | (sec, | added | | ICPS | |
| Group | (wt %) | (Nm) | max) | (ppm) | (mol %) | (ppm) | (mol %) |
| CG1 | 0 | 2.1 | 272 | 0 | 0 | 0 | 0 |
| EG15 | 25 | 2.5 | 212 | 63 | 0.175 | 40.7 | 0.113 |
| EG16 | 30 | 3.4 | 209 | 75 | 0.210 | 56.9 | 0.159 |
| EG17 | 50 | 4.6 | 182 | 126 | 0.350 | 104 | 0.289 |
| EG18 | 85 | 6.2 | 165 | 214 | 0.595 | 149 | 0.414 |

As shown in Table 20, the maximum torque in each of EG15 to EG18 is greater than that in CG1, and the maximum torque increases when the amount of P6 resin increases. In addition, the time to reach the maximum torque decreases when the amount of P6 resin added increases.

The results indicate that the polymeric compound containing the metal salt may accelerate the increase in intrinsic viscosity, and improve the performance of PMDA in chain extension of the polyester and the polyamide, and such improved effect is enhanced with the increased amount of the polymeric compound containing the metal salt.

### Example 6

The bottles made by the polymer composition of this disclosure (i.e., EG6) as described in Example 4 was further subjected to determination of the following properties. In addition, two polymer compositions of Comparative Group 8 to 9 (CG8 to CG9) as shown in Table were also prepared, along with the polymer composition of CG7 as prepared in Example 4, for making a respective one of bottles for comparison purpose using similar conditions to those of EG6.

TABLE 21

Polymer composition (wt %)

| Group | P1 | P2 | P3 | P6 |
|---|---|---|---|---|
| CG8 | 100 | — | — | — |
| CG7 | 94.9 | 0.1 | 5 | — |
| CG9 | 65 | — | 5 | 30 |
| EG6 | 64.9 | 0.1 | 5 | 30 |

### (1) Haze

Each of the bottles of CG7 to CG9 and EG6 was cut into a plurality of pieces. Four pieces (each having an area of 5 cm×5 cm) of each bottle were collected and subjected to determination of haze using a haze meter (Manufacturer: Nippon Denshoku; Model: NDH2000) according to the procedures set forth in ASTM D1003. The average value of the obtained haze for each bottle was calculated and recorded.

### (2) Oxygen Transmission Rate (OTR)

An OTR of each of the bottles of CG7 to CG9 and EG6 was measured using an oxygen transmission rate tester (Manufacturer: MOCON; Model: OX-IRAN® 2/21) according to the procedures set forth in ASTM D-3985.

### (3) Barrier Improvement Factor (BIF)

The O₂ BIF is defined as the OTR gas (O₂) permeability of the bottle of CG8 (PET only) relative to that of the bottle of each group.

The CO₂ BIF is defined as a CO₂ permeability (i.e., shelf life) of the bottle of each group relative to that of the bottle of CG8 (PET only), in which the shelf life was determined as follows.

To be specific, the bottle of each group was filled with de-ionized water, followed by addition of sodium bicarbonate and citric acid to generate CO₂ which fills the bottle. The bottle was then capped and the initial pressure inside the bottle (P₀) was determined. The bottle was then placed in a carbon dioxide measuring device (Manufacturer: MOCON; Model: PERMATRAN-C MODEL 10) to determine the amount of CO₂ that escaped from the bottle. The time when 17.5% of CO₂ escaped from the bottle was defined as the shelf life. The higher the shelf life is, the higher the CO₂ barrier property of the bottle is.

The determined properties of the bottles of each group were shown in Table 22.

TABLE 22

| | Average | | | | |
|---|---|---|---|---|---|
| | domain | | | | |
| | size | | OTR | O₂ | CO₂ |
| | (nm) | Haze | (mL/bottle · day · atm) | BIF | BIF |
| CG8 | — | 0.3% | 0.052 | 1 | 1 |
| CG7 | 580 | 13.2% | 0.021 | 2.48 | 1.40 |
| CG9 | 237 | 9.8% | 0.029 | 1.79 | 0.98 |
| EG6 | 207 | 4.3% | 0.013 | 4.00 | 1.09 |

“—”: Since CG8 includes PET only without MXD-6, there are no domains generated from the incompatibility of these two polymers (i.e., PET and MXD6).

As shown in Table 22, although the polymer composition of CG9 includes the polymeric compound containing the metal salt (P6 resin), the bottle prepared therefrom may have unsatisfactory gas barrier properties. The polymer composition of CG7 includes the multifunctional compound (P2 powder) as a chain extender, and thus the bottle prepared therefrom exhibits improved gas barrier properties, but has serious haze problem. As compared to CG7 and CG9, the polymer composition of EG6, which includes both of the polymeric compound containing the metal salt and the multifuntional compound, is capable of making a bottle having even improved OTR and O₂ BIF, indicating that the performance of the multifunctional compound in chain extension is further enhanced when the polymeric compound containing the metal salt is introduced into the polymer composition. Moreover, the bottle of EG6 has much lower haze and lower average domain size as compared to those of CG7 and CG9.

In sum, by adding the multifunctional compound (such as PMDA) to enhance viscosity of the polyester, and by adding the polymeric compound containing a salt of a metal (such as NaSIPE-co-PET, LiSIPE-co-PET, etc.) to accelerate the viscosity-enhancing effect of the multifunctional compound and to improve the performance of the multifunctional compound in chain extension of the polyester, the resultant melted product of the polymer composition of this disclosure can reach a desired viscosity relatively quickly, and can be easily processed using single or twin screw extruder in a cost and time-efficient manner. Moreover, during the preparation of plastic article, a screw extruder for granulation may also be dispensed. In addition, crystallization or other treatment (e.g., solid state polymerization) for granules can also be waived therefrom to simplify the preparation procedures. The plastic article obtained thereby has excellent properties (such as gas-barrier performance) and appearance (e.g., transparency).

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment”, an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A polymer composition comprising a polyester, a multifunctional compound and a polymeric compound containing a salt of a metal, wherein based on said polymer composition, said metal is present in an amount ranging from 0.01 mol % to 5.0 mol %, said multifunctional compound being selected from the group consisting of polyacid, polyanhydride, and the combination thereof.

2. The polymer composition of claim 1, further comprising a polyamide.

3. The polymer composition of claim 1, wherein, based on said polymer composition, said metal is present in an amount ranging from 0.01 mol % to 2.0 mol %.

4. The polymer composition of claim 1, wherein, based on said polymer composition, said metal is present in an amount ranging from 0.05 mol % to 1.4 mol %.

5. The polymer composition of claim 2, wherein, based on said polymer composition, said metal is present in an amount ranging from 0.05 mol % to 3.0 mol %.

6. The polymer composition of claim 2, wherein, based on said polymer composition, said metal is present in an amount ranging from 0.1 mol % to 1.4 mol %.

7. The polymer composition of claim 1, wherein said polyester is selected from the group consisting of aliphatic polyester, aromatic polyester, and the combination thereof.

8. The polymer composition of claim 1, wherein said multifunctional compound is selected from the group consisting of tricarboxylic acid, tricarboxylic acid anhydride, tetracarboxylic acid, tetracarboxylic acid anhydride, tetracarboxylic dianhydride, and combinations thereof.

9. The polymer composition of claim 8, wherein said multifunctional compound is selected from the group consisting of trimesic acid, pyromellitic acid, trimellitic anhydride, pyromellitic dianhydride, and combinations thereof.

10. The polymer composition of claim 1, wherein said polymeric compound is selected from the group consisting of polyolefin copolymer, copolyester, ethylene-mathacrylic acid copolymer, ethylene-methylacrylate copolymer, ethylene-ethylacrylate copolymer, ethylene-butylacrylate copolymer, and combinations thereof.

11. The polymer composition of claim 1, wherein said polymeric compound containing said salt of metal has a number average molecular weight greater than 5000 Daltons.

12. The polymer composition of claim 1, wherein said metal in said polymeric compound containing said salt of metal has a positive valence of 1 or 2.

13. The polymer composition of claim 12, wherein said metal is selected from the group consisting of an alkali metal, an alkali earth metal, and the combination thereof.

14. The polymer composition of claim 2, wherein said polyamide is prepared by polycondensation of aminocaproic acid, or polycondensation of a mixture including a diamine and a dicarboxylic acid with 6 to 22 carbon atoms.

15. The polymer composition of claim 14, wherein said dicarboxylic acid is selected from the group consisting of adipic acid, isophthalic acid, terephthalic acid, 1,4-cyclohexanedicarboxylic acid, resorcinol dicarboxylic acid, naphthalenedicarboxylic acid, and mixtures thereof, and wherein said diamine is selected from the group consisting of m-xylene diamine, p-xylene diamine, hexamethylenediamine, ethylene diamine, 1,4-cyclohexanedimethylamine, and mixtures thereof.

16. A method for preparing a resin composition, comprising: melt-mixing the polymer composition of claim 1 under heating, so as to obtain a mixture; and cooling the mixture.

17. The method of claim 16, wherein the polymer composition further includes a polyamide.

18. An article prepared from a polymer composition as claimed in claim 1.

19. The article of claim 18, wherein said polymer composition further includes a polyamide.

20. The article of claim 19, wherein, based on said article, said metal is present in an amount ranging from 0.05 mol % to 3.0 mol %.

21. The article of claim 19, wherein, based on said article, said metal is present in an amount ranging from 0.1 mol % to 1.4 mol %.

22. The article of claim 18, wherein said article is selected from the group consisting of a preform, a bottle, a sheet, a container, and a film.

23. The article of claim 19, wherein said article is selected from the group consisting of a preform, a bottle, a sheet, a container, and a film.

24. The article of claim 23, wherein said article is a bottle having domains with an average size that is not greater than 300 nm.

25. The article of claim 24, wherein more than 70% of the domains have a size not greater than 300 nm.

26. The article of claim 23, wherein said article is said preform having domains with an average size that is not greater than 150 nm.

27. The article of claim 26, wherein more than 80% of the domains have a size not greater than 200 nm.
